(19) United States
(12) Patent Application Publication
(10) Pub. No.: US 2021/0209616 A1
(43) Pub. Date: Jul. 8, 2021

(54) CROWD-DRIVEN DATA ANALYSIS AND RESPONSE MANAGEMENT

(71) Applicant: International Business Machines Corporation, Armonk, NY (US)

(72) Inventors: Paul R Bastide, Ashland, MA (US); Steven Lenker, Cambridge, MA (US); Kathleen Francis, Cambridge, MA (US); Xiaoyan Wang, Boston, MA (US)

(21) Appl. No.: 16/735,158

(22) Filed: Jan. 6, 2020

(51) Int. Cl. G06Q 30/02; G06Q 50/00; G06Q 30/06

(52) U.S. Cl. CPC G06Q 30/0201; G06Q 30/0625; G06Q 50/01

(57) ABSTRACT

Techniques for data analysis are provided. Data collected from one or more social media services is received, and a first product referenced in the received data is identified. The received data is evaluated using one or more natural language processing (NLP) techniques to determine a first sentiment reflected in the data, with respect to the first product. A shift from an existing sentiment to the first sentiment is determined with respect to the first product. Upon determining that the shift exceeds predefined criteria, a survey requesting information about the first product is transmitted to a first user associated with the received data. A first response is received from the first user, and one or more actions are initiated based at least in part on the first response.

### BACKGROUND

The present disclosure relates to data analysis, and more specifically, to evaluating crowd-sourced data to improve quality monitoring and response management.

Product defects and foodborne illnesses negatively affect tens of millions of people each year, and cause thousands of deaths. To reduce these externalities, food and product recalls are quite common. Typically, when there is reasonable suspicion that a product is causing or can cause consumer harm, a voluntary recall (begun by the distributor) or a mandatory recall (begun by the government and/or other regulatory authority) is initiated. The causes of the recall can vary substantially, including potential contamination, undeclared allergens, mislabeling, and the like. Preventing these harms is difficult and costly, often involving random sampling or products, and/or voluntary consumer reporting of issues. This introduces delay in the recall process, which increases the number that can be harmed.

### SUMMARY

According to one embodiment of the present disclosure, a method is provided. The method includes receiving data collected from one or more social media services, and identifying a first product referenced in the received data. The method further includes evaluating the received data using one or more natural language processing (NLP) techniques to determine a first sentiment reflected in the data, with respect to the first product. Additionally, the method includes determining a shift from an existing sentiment to the first sentiment with respect to the first product. Upon determining that the shift exceeds predefined criteria, the method includes transmitting, to a first user associated with the received data, a survey requesting information about the first product. The method further includes receiving a first response from the first user, and initiating one or more actions based at least in part on the first response.

According to a second embodiment of the present disclosure, a computer-readable storage medium is provided. The computer-readable storage medium contains computer program code that, when executed by operation of one or more computer processors, performs an operation. The operation includes receiving data collected from one or more social media services, and identifying a first product referenced in the received data. The operation further includes evaluating the received data using one or more natural language processing (NLP) techniques to determine a first sentiment reflected in the data, with respect to the first product. Additionally, the operation includes determining a shift from an existing sentiment to the first sentiment with respect to the first product. Upon determining that the shift exceeds predefined criteria, the operation includes transmitting, to a first user associated with the received data, a survey requesting information about the first product. The operation further includes receiving a first response from the first user, and initiating one or more actions based at least in part on the first response.

According to a third embodiment of the present disclosure, a system is provided. The system includes one or more computer processors, and a memory containing a program which, when executed by the one or more computer processors, performs an operation. The operation includes receiving data collected from one or more social media services, and identifying a first product referenced in the received data. The operation further includes evaluating the received data using one or more natural language processing (NLP) techniques to determine a first sentiment reflected in the data, with respect to the first product. Additionally, the operation includes determining a shift from an existing sentiment to the first sentiment with respect to the first product. Upon determining that the shift exceeds predefined criteria, the operation includes transmitting, to a first user associated with the received data, a survey requesting information about the first product. The operation further includes receiving a first response from the first user, and initiating one or more actions based at least in part on the first response.

### BRIEF DESCRIPTION OF THE SEVERAL VIEWS OF THE DRAWINGS

FIG. 1 depicts a system architecture of configured to analyze user data to improve response management, according to one embodiment disclosed herein.

FIG. 2 is a block diagram illustrating a response system configured to automatically monitor data and trigger appropriate actions, according to one embodiment disclosed herein.

FIG. 3 is a flow diagram illustrating a method for evaluating data to trigger appropriate remedial actions, according to one embodiment disclosed herein.

FIG. 4 is a flow diagram illustrating a method for identifying historical shifts in product sentiment, according to one embodiment disclosed herein.

FIG. 5 is a flow diagram illustrating a method for evaluating data to trigger response actions, according to one embodiment disclosed herein.

### DETAILED DESCRIPTION

Embodiments of the present disclosure provide techniques and architectures to analyze and evaluate data in order to identify trends and shifts in user sentiment, which can be indicative of defects that require response. Advantageously, embodiments of the present disclosure provide for near real-time identification of defects and/or concerns, which dramatically shortens the time needed to address the defect and/or concern. In one embodiment, the system collects and evaluates user data (e.g., collected from social media) to identify changes in sentiment with respect to any number of products. If user sentiment with respect to a particular product is declining, the system can take remedial action. In at least one embodiment, the system can generate and transmit a poll or survey to one or more consumers of the product. Additional action can be taken depending on the user responses.

For example, the system may recommend a product recall (or initiate a recall on its own), offer discounts for future purchases, present alternative products and/or updates, engage additional services (such as a cleaning service) if needed, and the like. In at least one embodiment, the system cross-references social media data (e.g., posts, conversations, and the like) with purchase history of the user in order to positively identify the product(s) being referenced. For example, if a post recites “these bananas are delicious,” the system can search purchase history of the user to identify the particular bananas bought (e.g., the producer), the location they were purchased, the date of purchase, and the like. In this way, the system can compare the user's sentiment with respect to the bananas with any number of other users who also purchased the same type of banana from the same (or a similar) location, at the same (or a similar) time.

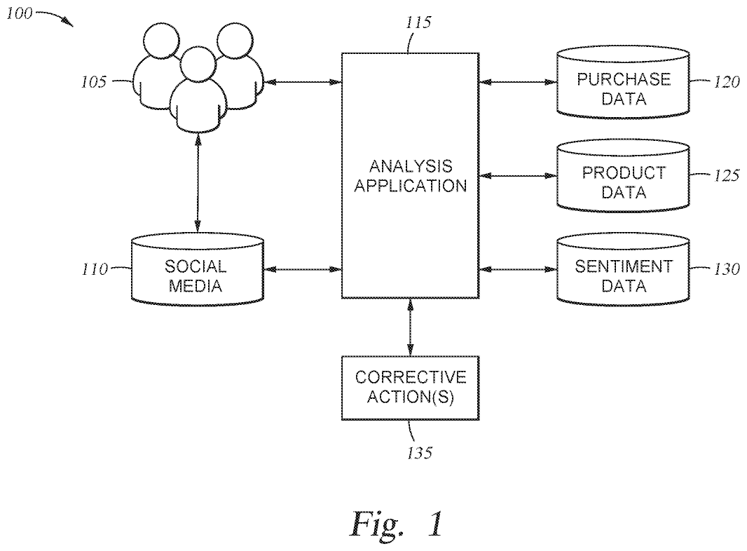

FIG. 1 depicts a System 100 architecture of configured to analyze user data to improve response management, according to one embodiment disclosed herein. As illustrated, an Analysis Application 115 retrieves and evaluates data from a number of sources, in order to generate and/or initiate Corrective Action(s) 135. In an embodiment, Users 105 interact with Social Media 110 to create and modify user data, which can include, for example, posts, articles, conversations, videos, images, and the like. In one embodiment, the data includes natural language text. In some embodiments, the Analysis Application 115 can use one or more techniques including caption generation and speech-to-text to generate natural language text from images and/or video.

As illustrated, the Analysis Application 115 is communicatively coupled with the repository for Social Media 110. Although a single repository is depicted, in embodiments, the Analysis Application 115 may interact with a number of social media platforms or services. In an embodiment, the Analysis Application 115 receives the user data from Social Media 110, and applies one or more natural language processing (NLP) techniques such as natural language classification (NLC) to identify product references. In one embodiment, the Analysis Application 115 does so, in part, using the repository of Product Data 125. In an embodiment, the Product Data 125 includes records for any number of products, where each record can identify the product, specify one or more tags associated with the product (e.g., to better identify it in user data), include a natural language description of the product (again to aid identification), indicate the identity of the producer/distributor/provider of the product, and the like.

For example, for a particular brand of bananas, the Product Data 125 may include tags such as “fruit” or “Banana Company” (the provider of the bananas), which may help recognize references to the product in user data. Similarly, the natural language description may include text such as “curved yellow fruit” to aid identification of the product in user data. In one such embodiment, the Analysis Application 115 can reference the Product Data 125 to determine whether a product is referenced in a given set of user data. In one embodiment, if the Analysis Application 115 determines that a product appears to be referenced, the Analysis Application 115 further cross-references this with the Purchase Data 120. For example, if the Analysis Application 115 believes the user has mentioned bananas, but cannot determine which type/brand, the Analysis Application 115 may analyze the user's Purchase Data 120. In at least one embodiment, even the Analysis Application 115 can conclusively identify the product (e.g., because the user directly stated the brand/type), the Analysis Application 115 nevertheless evaluates the Purchase Data 120 to confirm.

In an embodiment, the Purchase Data 120 includes records of prior purchases by the Users 105. In some embodiments, Users 105 must opt in to the Analysis Application 115 to allow analysis of their Social Media 110 and/or Purchase History 120. Each record in the Purchase Data 120 can include, for example, an identifier of the product purchased (e.g., a bar code or SKU), the location of the purchase (e.g., the particular storefront, and/or a geographic area), the time and/or date of the purchase, and the like. In one embodiment, while analyzing the user data, the Analysis Application 115 identifies the corresponding user and references the Purchase Data 120 to confirm whether the user purchased the product, and/or to more confidently identify the product.

In at least one embodiment, if no record of the purchase can be found in the Purchase Data 120, the Analysis Application 115 discards the user data. That is, if the Analysis Application 115 cannot determine when and/or where the user acquired the product, the Analysis Application 115 ignores the reference because it is not actionable. For example, the Analysis Application 115 cannot initiate a recall, provide incentives, or otherwise rectify any potential concerns if the product/purchase location cannot be ascertained. In some embodiments where the Analysis Application 115 is unable to conclusively identify the source, the Analysis Application 115 can assign a probability from (e.g., ranging from 0 to 1) indicating the likelihood of the identity. For example, suppose two brands of bananas are sold in a given region. If the system knows the user purchased bananas but cannot tell which of the two brands, the Analysis Application 115 may assign a probability of 0.5. The system can then determine whether to continue the analysis or to discard the data based on this probability.

Once the product is identified, the Analysis Application 115 performs sentiment analysis to determine the sentiment of the user, with respect to the product. In one embodiment, the sentiment is classified as positive and/or negative, along with a score (e.g., from zero to one) indicating the strength of the sentiment. In at least one embodiment, a single post may be both positive and negative. That is, in one embodiment, the Analysis Application 115 can separately evaluate and score the positivity and the negativity of the post, resulting in two separate scores. In another embodiment, the Analysis Application 115 can generate a single sentiment score (e.g., by aggregating the positive and negative scores).

In the illustrated embodiment, the Analysis Application 115 generates and stores a record of the analyzed user data in the Sentiment Data 130. In at least one embodiment, the Sentiment Data 130 includes records for prior references to products, from any number of users. Each record can include, for example, the time and date that the data was produced/published, the time and date of the purchase, an identifier of the user or users who posted the message, a link or pointer to the message, an indication of the determined sentiment, a location of the user at the time of the post and/or purchase, and the like. In one embodiment, the location is a global positioning system (GPS) coordinate. In another, the location is a geographic region.

In an embodiment, the Analysis Application 115 can then analyze the Sentiment Data 130 to determine whether there has been a recent shift in sentiment, with respect to the product. For example, the Analysis Application 115 can retrieve records that correspond to the product and region over a period of time, and determine whether the aggregate sentiment has shifted (e.g., from positive or neutral to negative). If so, in one embodiment, the Analysis Application 115 generates and transmits a survey or questionnaire to one or more User(s) 105 who recently posted messages relating to the product. The survey can include any number of questions, asking the User 105 to provide feedback about the product.

In embodiments, the user feedback can include numerical responses (e.g., rating the product experience), natural language responses (e.g., open-ended questions asking about the experience), and the like. After reviewing the feedback, the Analysis Application 115 can determine whether Corrective Actions 135 can or should be taken. In at least one embodiment, if the User(s) 105 do not respond within a predefined time (e.g., 24 hours), the Analysis Application 115 can transmit a reminder. Further, in some embodiments, if the User(s) 105 do not respond, the Analysis Application 115 refrains from taking Corrective Actions 135.

In one embodiment, the Analysis Application 115 analyzes the feedback using NLP techniques to identify concerns or issues, and initiate Corrective Actions 135. These actions can include, for example, beginning a recall, transmitting an apology and/or incentive to the User 105 to purchase the product again, suggesting alternatives, and the like. In at least one embodiment, if the responses indicate that additional action is required (e.g., a cleaning or maintenance service is required to remedy the harm caused by the product), the Analysis Application 115 can engage such a service. Although the present disclosure discusses negative sentiment shifts as examples, embodiments of the present disclosure are readily applicable to positive shifts as well. For example, if sentiment has shifted in a positive direction, the Analysis Application 115 may transmit, to one or more retailers in the region, an indication of the shift, and/or a suggestion to order more of the product and/or to change advertising activity. In at least one embodiment, the Analysis Application 115 can transmit a survey to confirm the sentiment shifts, prior to taking further action.

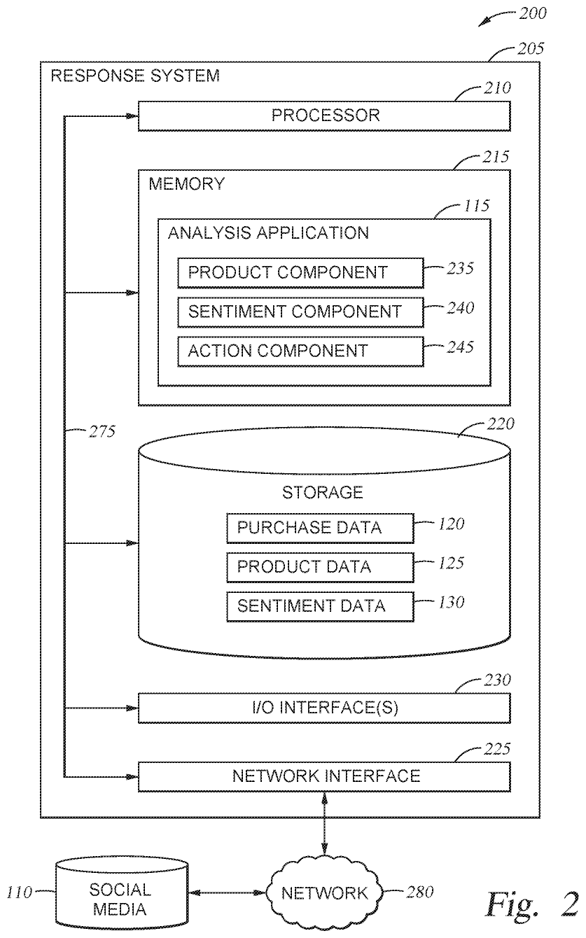

FIG. 2 is a block diagram illustrating a Response System 205 configured to automatically monitor data and trigger appropriate actions, according to one embodiment disclosed herein. Although depicted as a physical device, in embodiments, the Response System 205 may be implemented using virtual device(s), and/or across a number of devices (e.g., in a cloud environment). As illustrated, the Response System 205 includes a Processor 210, Memory 215, Storage 220, a Network Interface 225, and one or more I/O Interfaces 230. In the illustrated embodiment, the Processor 210 retrieves and executes programming instructions stored in Memory 215, as well as stores and retrieves application data residing in Storage 220. The Processor 210 is generally representative of a single CPU and/or GPU, multiple CPUs and/or GPUs, a single CPU and/or GPU having multiple processing cores, and the like. The Memory 215 is generally included to be representative of a random access memory. Storage 220 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output devices (such as keyboards, monitors, etc.) are connected via the I/O Interface(s) 230. Further, via the Network Interface 225, the Response System 205 can be communicatively coupled with one or more other devices and components (e.g., via the Network 280, which may include the Internet, local network(s), and the like). As illustrated, the Processor 210, Memory 215, Storage 220, Network Interface(s) 225, and I/O Interface(s) 230 are communicatively coupled by one or more Buses 275. As illustrated, the Response System 205 is communicatively coupled with one or more repositories of Social Media 110.

In the illustrated embodiment, the Storage 220 includes Purchase Data 120, Product Data 125, and Sentiment Data 130. Although depicted as residing in Storage 220, in embodiments, the Purchase Data 120, Product Data 125, and Sentiment Data 130 can be stored in any suitable location, including Memory 215, and in one or more remote storage locations (e.g., located in the cloud). As illustrated, the Memory 215 includes the Analysis Application 115. Although depicted as software residing in Memory 215, the functionality of the Analysis Application 115 may be implemented using software, hardware, or a combination of software and hardware.

The Analysis Application 115 includes a Product Component 235, a Sentiment Component 240, and an Action Component 245. Although illustrated as discrete components for conceptual clarity, in embodiments, the operations of the Product Component 235, Sentiment Component 240, and Action Component 245 can be combined or distributed across any number of components. In the illustrated embodiment, the Product Component 235 evaluates user data (e.g., text collected from social media, messaging platforms, and the like) in order to identify references to particular products reflected in the Product Data 125.

For example, the Product Component 235 can use the tags, text descriptions, company identifiers, and the like reflected in the Product Data 125 for a given product in order to identify the product(s) referenced in the data (or to narrow down the set of products it could potentially be referencing). In at least one embodiment, the Product Component 235 further cross-references with the Purchase Data 120 for the user, in order to more-conclusively identify the product(s) being referenced. For example, if the Product Component 235 determines that the post relates to bananas, the Product Component 235 can retrieve and analyze the user's Purchase Data 120 in order to identify the particular brand of bananas that the user recently purchased. In some embodiments, the Product Data 125 can be altered, such as by being updated with matching tags, text, or grammars in order to better identify products. Additionally, in some embodiments, the user can be prompted to identify or confirm the product or purchase associated with a message or post.

In one embodiment, if the product has been successfully identified, the Sentiment Component 240 analyzes the text of the post using one or more NLP techniques in order to determine the sentiment associated with the product. This may include determining whether the post is positive, negative, or neutral. In at least one embodiment, the Sentiment Component 240 further generates a positivity score and/or negativity score, reflecting the strength of the sentiment. For example, the Sentiment Component 240 may generate a positivity score of 0.9 and a negativity score of 0.2, indicating that the post is generally positive. In some embodiments, the positive and negative scores are not dependent on each other. That is, a given text may have a relatively high positivity score (e.g., 0.8) as well as a relatively high negativity score (e.g., 0.9).

As illustrated, once the product is identified and the text is evaluated, the Sentiment Component 240 can generate a new record, to be stored in the Sentiment Data 130, reflecting the new utterance. The Action Component 245 can then determine whether the sentiment for the product, with respect to the region and/or window of time, has shifted. In one embodiment, for example, the Action Component 245 queries the Sentiment Data 130 to retrieve all records that specify the newly-identified product, where the corresponding location matches (or is within a predefined distance of) the newly-identified location, and where the user data was posted (or the product was purchased) within a predefined window of time.

In one embodiment, the predefined window of time corresponds to an expected lifespan of the product. That is, the window can correspond to the length of time that the product is expected to be in use. For example, fresh produce may have a relatively short window (e.g., a few days), while canned goods have a much longer window (e.g., months or years). In this way, the Action Component 245 can refrain from taking action based on data that is outdated. For example, the current sentiment for a banana product is likely unrelated to the sentiment for the same banana product purchased several years ago.

In one embodiment, the Action Component 245 further organizes the data based on the vendor or distributor from which the product was purchased. For example, the Action Component 245 may generate a first aggregate sentiment using the historical Sentiment Data 130 corresponding to a first purchase location, and a second sentiment using the Sentiment Data 130 corresponding to a second purchase location. In embodiments, the Action Component 245 evaluates the historical Sentiment Data 130 to determine whether there has been a shift in sentiment. For example, if the average or aggregate sentiment for the last two days is more negative than the average or aggregate sentiment for the two days prior, the Action Component 245 can compare this difference to one or more predefined thresholds to determine whether there is a shift that justifies corrective action.

In one embodiment, if the sentiment shift is sufficient, the Action Component 245 generates and transmits one or more surveys to user(s) who purchased the product. This may be done using a template, or randomly selecting from a predefined set of questions. In one embodiment, for each user that does not respond, the Action Component 245 can transmit one or more reminders or alternate surveys. Additionally, the Action Component 245 can aggregate and/or evaluate the responses to determine what actions, if any, should be taken. This can be accomplished using NLP to identify user intent in free-text responses, as well as potential corrections. For example, if the responses generally indicate that the bananas turned bad quickly, the Action Component 245 can determine that an appropriate response is to offer a discount on future banana purchases. If the responses indicate that the bananas made the consumers ill, the Action Component 245 may determine that a recall is more appropriate. The Action Component 245 can then initiate whatever actions it identifies. In at least one embodiment, the Action Component 245 prompts an administrator for approval prior to implementing the action (e.g., prior to initiating a recall, or transmitting a discount).

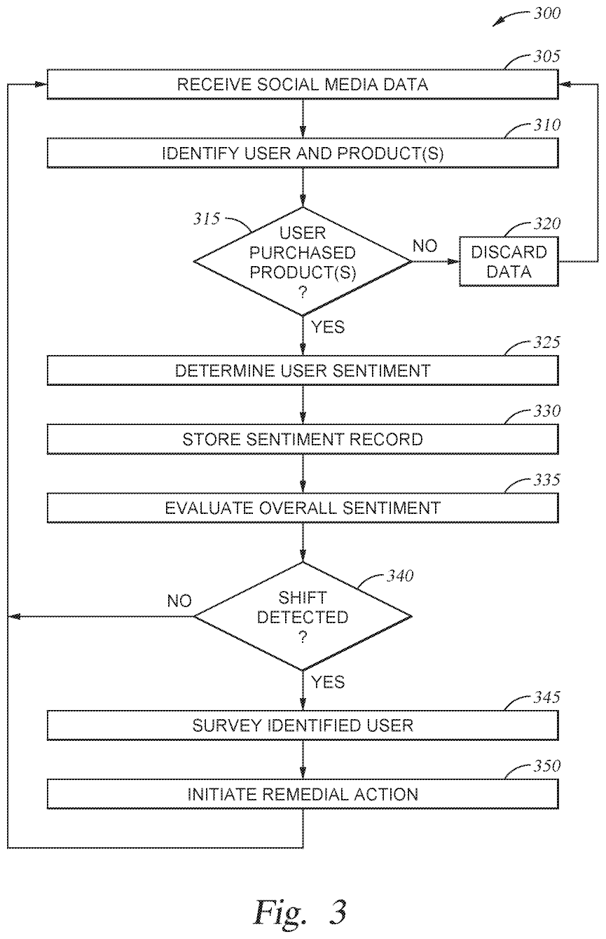

FIG. 3 is a flow diagram illustrating a method 300 for evaluating data to trigger appropriate remedial actions, according to one embodiment disclosed herein. The method 400 begins at block 305, where an Analysis Application 115 receives social media data from one or more services or repositories. The data can include, for example, public or private posts, messages or conversations, and the like. In one embodiment, the social media data is received for users who have opted-in to the Analysis Application 115. Additionally, the data may be received as a push (e.g., transmitted automatically on a periodic basis to the Analysis Application 115), pulled (e.g., periodically requested by the Analysis Application 115), and the like.

The method 300 then proceeds to block 310, where the Analysis Application 115 identifies the user(s) associated with the post (e.g., the user that submitted the data), and/or the product(s) referenced or otherwise referred to in the data. In one embodiment, the Analysis Application 115 applies NLC to identify potential product references. For example, given text such as “these bananas are delicious, but turned bad so quickly,” the Analysis Application 115 may identify “bananas” as a product reference. Similarly, for a post such as “had burgers at Main Diner last night, but I think it made me sick” can identify “burgers” and/or “Main Diner” as potential product references.

Notably, in at least one embodiment, the product identity may not be conclusive at this stage. For example, the user's reference to “these bananas” does not indicate what brand of banana. However, the user's post referencing “burgers” at “Main Diner” may be sufficient to conclusively identify the relevant product(s). In the illustrated embodiment, the method 300 then continues to block 315, where the Analysis Application 115 determines whether the identified user purchased the identified product(s). That is, the Analysis Application 115 determines whether the product can be found in the user's purchase history.

In one embodiment, if the product was conclusively identified (e.g., dinner at “Main Diner”), the Analysis Application 115 can determine whether the user's purchase history indicates such a purchase. Additionally, if the product was not conclusively identified (e.g., “bananas”), the Analysis Application 115 can search the purchase history to determine whether the user recently purchased any bananas, and if so, identify the brand of bananas and/or the purchase location based on the purchase records. In at least one embodiment, The Analysis Application 115 can map general references to the likely components. For example, a reference to dinner may likely be an implicit reference to “macaroni” and “cheese.”

In the illustrated embodiment, if the product is not reflected in the user's purchase data, the method 300 proceeds to block 320, where the Analysis Application 115 discards the received data and refrains from any additional processing or evaluation. Notably, the Analysis Application 115 will therefore not take any action (e.g., initiating a recall) based on the data. The method 300 then returns to block 305. In at least one embodiment, however, if the product can be conclusively identified (e.g., because the user specifically mentions the brand and/or distributor), the method 300 can proceed to block 325 regardless of whether the product is found in the purchase history.

Returning to block 315, if the product is reflected in the purchase history, the method 300 proceeds to block 325, where the Analysis Application 115 determines the sentiment of the user, with respect to the product. In some embodiments, the Analysis Application 115 uses NLP to do so. In at least one embodiment, the Analysis Application 115 uses one or more pre-trained sentiment analysis models and/or predefined sentiment analysis techniques to score the received data based on its positivity, negativity, and the like. In some embodiments, the Analysis Application 115 aggregates these scores to create an overall sentiment for the data. This can include, for example, classifying the text as generally positive, negative, neutral, or mixed by comparing the positivity and/or negativity scores to one or more thresholds.

The method 300 then proceeds to block 330, where the Analysis Application 115 stores a sentiment record reflecting the received data. In an embodiment, the record includes an indication of the product, the sentiment, the region of the purchase and/or of the post, the time/date of the purchase and/or the post, and the like. At block 335, the Analysis Application 115 evaluates the overall or aggregate sentiment for the product(s) identified in block 310, based on the historical sentiment records. As discussed above, this can include retrieving one or more records that correspond to the same product, region, and/or timeframe as the newly-received data. This allows the Analysis Application 115 to determine the current sentiment, prior sentiments during historical windows of time, and the like.

At block 340, the Analysis Application 115 determines whether there has been a shift in user sentiment in the region, with respect to the product and window of time. For example, the Analysis Application 115 may determine that the sentiment was positive but is now neutral or negative, was neutral but is now positive or negative, and/or was negative but is now neutral or positive. In some embodiments, the Analysis Application 115 compares the shift to predefined thresholds in order to determine whether the shift justifies action. For example, if the trend is slightly negative, the Analysis Application 115 may determine that no action is needed at this time.

If no actionable shift is detected, the method 300 returns to block 305 to receive and analyze additional user data. If an actionable shift is identified, the method 300 proceeds to block 345, where the Analysis Application 115 surveys at least the newly-identified user. In some embodiments, the Analysis Application 115 additionally surveys one or more of the other users who recently purchased the product, as reflected in the sentiment records. In at least one embodiment, the Analysis Application 115 can further survey users that purchased the product (reflected in the purchase records), even if there are no sentiment records associated with the purchase (e.g., the user has not posted about the purchase on social media).

In one embodiment, the Analysis Application 115 generates surveys by replacing placeholders in a predefined template. For example, the template may include “Hello [USER], we are writing to ask about your recent purchase of [PRODUCT] from [LOCATION].” In an embodiment, the Analysis Application 115 can fill these placeholders with the corresponding data for a given user. In another embodiment, the Analysis Application 115 randomly selects from a predefined set of questions, to be included in the survey. At block 350, depending on the user responses, the Analysis Application 115 initiates remedial action(s). In at least one embodiment, the Analysis Application 115 can send surveys to guardians or alternative contacts for the original user, as the user may be incapacitated or otherwise unavailable to respond.

In one embodiment, the Analysis Application 115 applies NLP to the responses to identify the issue/concern, and selects an appropriate action using predefined correlations. For example, if the survey responses indicate that the product went bad, but that no harm or illness was caused, the best action may be a full or partial refund, discounts for future purchases, and the like. In contrast, if the responses indicate that the user(s) suffered illness, the best action may include a recall. In such an embodiment, the Analysis Application 115 can directly notify the producer, provider, and/or distributor of the product, in order to facilitate and expedite the recall process. The method 300 then returns to block 305.

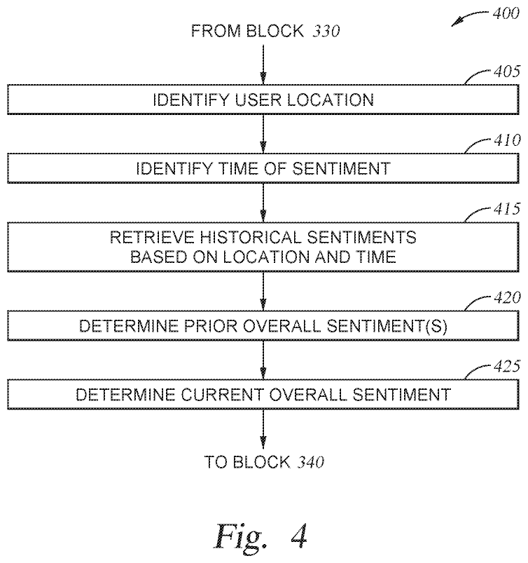

FIG. 4 is a flow diagram illustrating a method 400 for identifying historical shifts in product sentiment, according to one embodiment disclosed herein. In an embodiment, the method 400 provides additional detail for block 335 of FIG. 3. The method 400 begins at block 405, where the Analysis Application 115 identifies the user location. In embodiments, this location can correspond to the location of the user at the time of posting or publishing the received social media data, and/or the location of the purchase. Further, at block 410, the Analysis Application 115 identifies the date and time when the sentiment was conveyed or experienced (e.g., when the post was published). In at least one embodiment, the Analysis Application 115 additional identifies the date and time of the purchase. The method 400 then proceeds to block 415.

At block 415, the Analysis Application 115 retrieves historical sentiment records based on the identified time and location. In one embodiment, this includes identifying records that are within a predefined window around the identified time. Similarly, in an embodiment, the Analysis Application 115 retrieves records that are within a predefined distance from the identified location (or are within the same predefined geographic region). At block 420, the Analysis Application 115 determines the overall sentiment with respect to the product, as of a prior point in time. In one embodiment, this is accomplished by aggregating user sentiment for a window of time immediately prior to the current window of time.

Further, at block 425, the Analysis Application 115 determines the overall sentiment for the current window of time. This can involve aggregating sentiment records for the current time. In this way, the Analysis Application 115 can determine whether user sentiment has shifted or changed with respect to the product, within the defined region and/or timeframe.

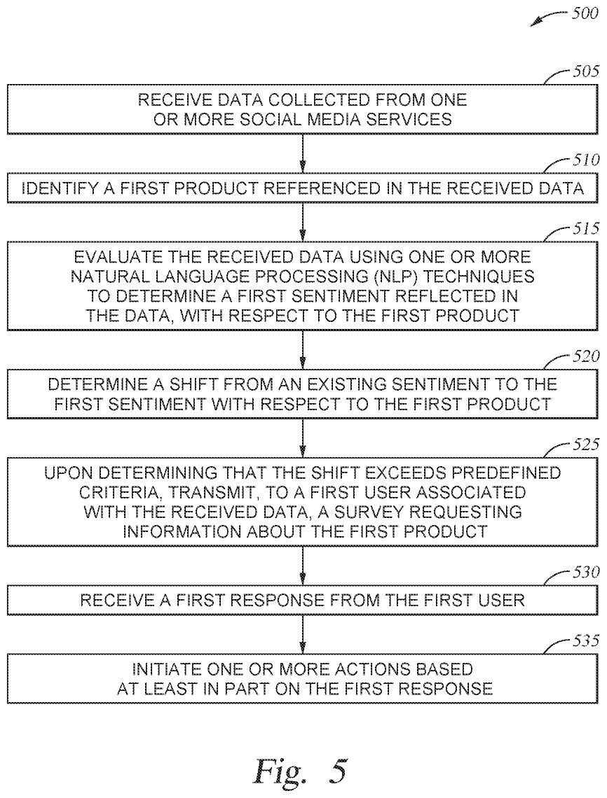

FIG. 5 is a flow diagram illustrating a method 500 for evaluating data to trigger response actions, according to one embodiment disclosed herein. The method 500 begins at block 505, where an Analysis Application 115 receives data collected from one or more social media services. At block 510, the Analysis Application 115 identifies a first product referenced in the received data. Additionally, at block 515, the Analysis Application 115 evaluates the received data using one or more natural language processing (NLP) techniques to determine a first sentiment reflected in the data, with respect to the first product. The method 500 then proceeds to block 520, where the Analysis Application 115 determines a shift from an existing sentiment to the first sentiment with respect to the first product. At block 525, upon determining that the shift exceeds predefined criteria, the Analysis Application 115 transmits, to a first user associated with the received data, a survey requesting information about the first product. The method 500 continues to block 530, where the Analysis Application 115 receives a first response from the first user. Further, at block 535, the Analysis Application 115 initiates one or more actions based at least in part on the first response.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding and/or following, reference is made to embodiments presented in this disclosure. However, the scope of the present disclosure is not limited to specific described embodiments. Instead, any combination of the preceding and/or following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding and/or following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the Analysis Application 115) or related data available in the cloud. For example, the Analysis Application 115 could execute on a computing system in the cloud and identify product references in textual data. In such a case, the Analysis Application 115 could evaluate user sentiment over time, and store sentiment records at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
receiving data collected from one or more social media services;
identifying a first product referenced in the received data;
evaluating the received data using one or more natural language processing (NLP) techniques to determine a first sentiment reflected in the data, with respect to the first product;
determining a shift from an existing sentiment to the first sentiment with respect to the first product;
upon determining that the shift exceeds predefined criteria, transmitting, to a first user associated with the received data, a survey requesting information about the first product;
receiving a first response from the first user; and
initiating one or more actions based at least in part on the first response.

2. The method of claim 1, wherein determining the shift comprises evaluating changes in the existing sentiment with respect to the first product over a predefined window of time.

3. The method of claim 2, wherein determining the shift further comprises evaluating changes in the existing sentiment with respect to the first product within a predefined geographic area.

4. The method of claim 2, wherein the predefined window of time corresponds to an expected shelf life of the first product.

5. The method of claim 1, wherein identifying the first product comprises:
identifying the first user associated with the received data;
retrieving purchase history of the first user; and
identifying, in the purchase history of the first user, an indication that the first user purchased the first product.

6. The method of claim 1, wherein identifying the first product comprises:
searching a product database, wherein the product database includes (i) an indication of the first product, (ii) at least one tag used to identify the first product, (iii) a natural language description of the first product, and (iv) an identifier of an entity that provides the first product.

7. The method of claim 1, the method further comprising:
storing, in a sentiment database, an indication of (i) the first product, (ii) the first user, (iii) the first sentiment, (iv) a location of the first user, and (v) a pointer to the received data;
receiving additional data, from a second user, collected from the one or more social media services;
identifying the first product referenced in the received additional data;
retrieving purchase history of the second user; and
upon failing to identify, in the purchase history of the second user, an indication that the second user purchased the first product, discarding the received additional data.

8. A computer-readable storage medium containing computer program code that, when executed by operation of one or more computer processors, performs an operation comprising:
receiving data collected from one or more social media services;
identifying a first product referenced in the received data;
evaluating the received data using one or more natural language processing (NLP) techniques to determine a first sentiment reflected in the data, with respect to the first product;
determining a shift from an existing sentiment to the first sentiment with respect to the first product;
upon determining that the shift exceeds predefined criteria, transmitting, to a first user associated with the received data, a survey requesting information about the first product;
receiving a first response from the first user; and
initiating one or more actions based at least in part on the first response.

9. The computer-readable storage medium of claim 8, wherein determining the shift comprises evaluating changes in the existing sentiment with respect to the first product over a predefined window of time.

10. The computer-readable storage medium of claim 9, wherein determining the shift further comprises evaluating changes in the existing sentiment with respect to the first product within a predefined geographic area.

11. The computer-readable storage medium of claim 9, wherein the predefined window of time corresponds to an expected shelf life of the first product.

12. The computer-readable storage medium of claim 8, wherein identifying the first product comprises:
identifying the first user associated with the received data;
retrieving purchase history of the first user; and
identifying, in the purchase history of the first user, an indication that the first user purchased the first product.

13. The computer-readable storage medium of claim 8, wherein identifying the first product comprises:
searching a product database, wherein the product database includes (i) an indication of the first product, (ii) at least one tag used to identify the first product, (iii) a natural language description of the first product, and (iv) an identifier of an entity that provides the first product.

14. The computer-readable storage medium of claim 8, the operation further comprising:
storing, in a sentiment database, an indication of (i) the first product, (ii) the first user, (iii) the first sentiment, (iv) a location of the first user, and (v) a pointer to the received data;
receiving additional data, from a second user, collected from the one or more social media services;
identifying the first product referenced in the received additional data;
retrieving purchase history of the second user; and
upon failing to identify, in the purchase history of the second user, an indication that the second user purchased the first product, discarding the received additional data.

15. A system comprising:
one or more computer processors; and
a memory containing a program which when executed by the one or more computer processors performs an operation, the operation comprising:
receiving data collected from one or more social media services;
identifying a first product referenced in the received data;
evaluating the received data using one or more natural language processing (NLP) techniques to determine a first sentiment reflected in the data, with respect to the first product;
determining a shift from an existing sentiment to the first sentiment with respect to the first product;
upon determining that the shift exceeds predefined criteria, transmitting, to a first user associated with the received data, a survey requesting information about the first product;
receiving a first response from the first user; and
initiating one or more actions based at least in part on the first response.

16. The system of claim 15, wherein determining the shift comprises evaluating changes in the existing sentiment with respect to the first product over a predefined window of time.

17. The system of claim 16, wherein determining the shift further comprises evaluating changes in the existing sentiment with respect to the first product within a predefined geographic area, and wherein the predefined window of time corresponds to an expected shelf life of the first product.

18. The system of claim 15, wherein identifying the first product comprises:
identifying the first user associated with the received data;
retrieving purchase history of the first user; and
identifying, in the purchase history of the first user, an indication that the first user purchased the first product.

19. The system of claim 15, wherein identifying the first product comprises:
searching a product database, wherein the product database includes (i) an indication of the first product, (ii) at least one tag used to identify the first product, (iii) a natural language description of the first product, and (iv) an identifier of an entity that provides the first product.

20. The system of claim 15, the operation further comprising:
storing, in a sentiment database, an indication of (i) the first product, (ii) the first user, (iii) the first sentiment, (iv) a location of the first user, and (v) a pointer to the received data;
receiving additional data, from a second user, collected from the one or more social media services;
identifying the first product referenced in the received additional data;
retrieving purchase history of the second user; and
upon failing to identify, in the purchase history of the second user, an indication that the second user purchased the first product, discarding the received additional data.
